(19) United States
(12) Patent Application Publication
(10) Pub. No.: US 2010/0332726 A1
(43) Pub. Date: Dec. 30, 2010

(54) STRUCTURE AND METHOD FOR MANAGING WRITING OPERATION ON MLC FLASH MEMORY

(75) Inventor: Chih-Hung Wang, Yunlin County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: SOLID STATE SYSTEM CO., LTD., Hsinchu (TW)

(21) Appl. No.: 12/492,158

(22) Filed: Jun. 26, 2009

(51) Int. Cl. G06F 12/00; G06F 12/02

(52) U.S. Cl. 711/103; 711/165; 365/230.03; 711/E12.001; 711/E12.002; 711/E12.008

(57) ABSTRACT

A method for managing a writing operation for a multi-level cell (MLC) nonvolatile memory by a host is provided. The MLC nonvolatile memory has a plurality of MLC blocks, each MLC cell of each MLC block can store multiple logical data bits. The method includes forming a turbo writing unit from the spare block pool; writing a data sent by the host to the turbo writing unit; and changing the role of the turbo writing unit into a turbo data unit. The turbo writing unit is formed with at least one of the MLC blocks, each MLC cell of the at least one of the MLC blocks stores a portion of the logical data bits the MLC cell is capable of storing.

### BACKGROUND OF THE INVENTION

1. Field of Invention

The invention is related to a controller management for a nonvolatile memory. Particularly, the present invention is related to a writing operation for the MLC flash memory.

2. Description of Related Art

Nonvolatile memory chips, which include nonvolatile memory arrays, have various applications for storing digital information. One such application is for storage of large amounts of digital information for use by digital cameras, as replacements for hard disk within personal computer (PCs) and so forth. Nonvolatile memory arrays are comprised of various types of memory cells, such as NOR, NAND and other types of structures known to those of ordinary skill in the art that have the characteristic of maintaining information stored therein while power is disconnected or disrupted.

FIG. 1 is a block diagram, schematically illustrating architecture of flash memory card. In FIG. 1, the host 100 can access data stored in a flash disk 102, in which the flash disk 102 includes a control unit 104 and a memory unit 106. A memory unit may include one or more memory chips. In access operation, the host 100 usually accesses the data in the memory module 106 via the control unit 104 at the requested address. In addition to communicating with the host, the control unit 104 also takes responsibility of managing the memory unit 106. The flash memory storage device is then configured as a drive by the host. FIG. 2 is a mapping table maintained by the control unit. From the host side, such a drive includes a plurality of logical blocks 108 arranged in the control unit 104, each of which can be addressed by the host. Namely, the host can access all the logical space including logical block 0, logical block 1, and logical block M-1.

A flash memory chip generally is divided into a plurality of storage units, like blocks which include one or more sectors. As shown in FIG.2, the physical space of the flash memory module includes physical block 0, physical block1, . . . , and physical block N-1. The logical space used by the host is always less than the physical space because some of the physical blocks may be defective or used by the controller for managing the flash memory module. One task of the controller is to create the logical space for host access. Indeed, the host can not directly address the physical space so that the controller must maintain the mapping relations between the logical blocks and the physical blocks. Such a mapping information is usually called as a mapping table and can be stored in the specific physical blocks or loaded into the SRAM within the controller. If a host asks for reading a particular logical block, the controller will look up the mapping table for identifying which physical block to be accessed, transfer data from the physical block to itself, and then transfer data from itself to the host.

FIG. 3A is a drawing, schematically illustrating the conventional mapping architecture. The data block and the writing block are formed and managed by the control unit. Each of them includes at least one physical block. In FIG. 3A, the logical block 300 is used by the host to write a data into the data block 302. However, since the overhead occurs from erase-then-program architecture, when the data will be re-written into the data block 302, the data is temporarily written to a writing block 304, instead. The writing block 304 also, functions as a buffer block or a spare block in the memory device. In other words, the writing block 304 in the usual accessing operation for the flash memory is severing as a buffer block for the host to write data instead of directly writing into the data block. The function of the data block is to store original data and the writing block is used as a: temporary storage for the current write request from the host. When the writing block 304 is, for example, fully written, then a swap action between the data block 302 and the writing block 304 is necessary. FIG. 3B is a drawing, schematically illustrating how to recycle these blocks. The swap operation generally means that the writing block is newly allocated as a data block to take the role of the previously allocated data block. However, the replaced data block can be considered as an old block so that the old data block is erased and then becomes a spare block. The spare block can be recycled and then be allocated out to server as a current writing block if the control unit needs such a writing block for the host in responding to a write request.

The conventional memory cells of the nonvolatile memory for the foregoing operation is mainly based on single-bit memory cell without further describe. A new generation of memory with multiple storage bits in one cell, so called multilevel cell (MLC) memory, has been developed. How to manage the MLC block is an issue for further development.

### SUMMARY OF THE INVENTION

The invention provides a method for managing a writing operation from a host for a multi-level cell (MLC) nonvolatile memory having multiple MLC blocks. The method includes arranging a spare block pool comprising at least a portion of the MLC blocks of the MLC nonvolatile memory available to be allocated for writing data. A turbo writing unit is formed from a spare block pool. A data sent by the host is written to the turbo writing unit. After finishing writing the turbo writing unit, the turbo writing unit just in finish is treated as a turbo data unit. The data stored in the turbo data unit is copied into one of the MLC blocks allocated from the spare block pool to replace the turbo data unit. The turbo writing unit is formed with at least one of the MLC blocks, not all of the MLC cells of the at least one of the MLC blocks store data with all of the logical data bits on which the MLC cell is capable of storing.

In an aspect of the invention, for example, the step of forming the turbo writing unit is to form the turbo writing unit with two of the MLC blocks, wherein each of the MLC cell of the MLC blocks has a storage capacity of two logical data bits.

In an aspect of the invention, for example, each of the MLC cell stores at least one logical data bit while it is capable of storing two logical data bits.

In an aspect of the invention, for example, the step of forming the turbo writing unit is forming the turbo writing unit with three of the MLC blocks, wherein each of the MLC cell of the MLC blocks has a storage capacity of three logical data bits.

In an aspect of the invention, for example, each MLC cell stores at least one logical data bit while the MLC cell of the MLC blocks is capable of storing three logical data bits.

In an aspect of the invention, for example, the step of forming the turbo writing unit is performed when the total number of the turbo writing units and the turbo data unit in use doesn't exceed a presetable threshold.

In an aspect of the invention, for example, the turbo writing unit is formed to write the data from the host when the total number of the available MLC blocks in the spare block pool is larger than a presetable threshold.

In an aspect of the invention, for example, the method further includes copying the data stored in the turbo data unit into one of the MLC blocks allocated from the spare block pool to serve as a data block for replacing the turbo data unit.

The invention also provides a block structure for a multi-level cell (MLC) nonvolatile memory, the MLC nonvolatile memory having a plurality of MLC blocks. Each MLC cell of each MLC block can store multiple bits of data. The block structure includes a spare block pool, a turbo writing unit, a turbo data unit and a data block. The spare block pool includes at least a portion of the MLC blocks of the MLC nonvolatile memory available to be allocated for writing data; and a data block. The turbo writing unit is allocated from the spare block pool for storing data from a host. The turbo writing unit comprises at least one of the MLC blocks, and not all of the MLC cells of the at least one of the MLC blocks store data with all of the logical data bits on which the MLC cell is capable of storing. After finishing writing data to the turbo writing unit, the turbo writing unit is treated as the turbo data unit. The data block is one of the MLC blocks allocated from the spare block pool for storing the data copied from the turbo data unit.

In an aspect of the invention, for example, the turbo writing unit comprises two blocks of the MLC blocks.

In an aspect of the invention, for example, each MLC cell has a storage capacity of two logical data bits.

In an aspect of the invention, for example, the turbo writing unit comprises three blocks of the MLC blocks.

In an aspect of the invention, for example, each MLC cell has a storage capacity of three logical data bits.

In an aspect of the invention, for example, the turbo writing unit is allocated to write the data from the host when the total number of the sum of the turbo data units and the turbo writing units in use doesn't exceed a preset threshold.

In an aspect of the invention, for example, the turbo writing unit is allocated to write the data from the host when the total number of the available MLC blocks in the spare block pool is larger than a preset threshold.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram, schematically illustrating architecture of flash memory card.

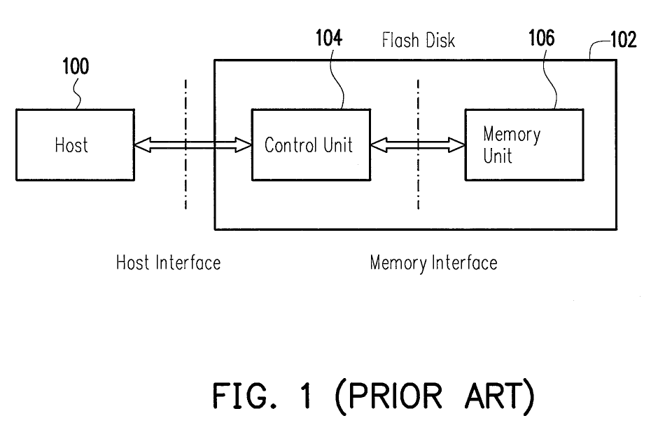

FIG. 2 is a mapping table.

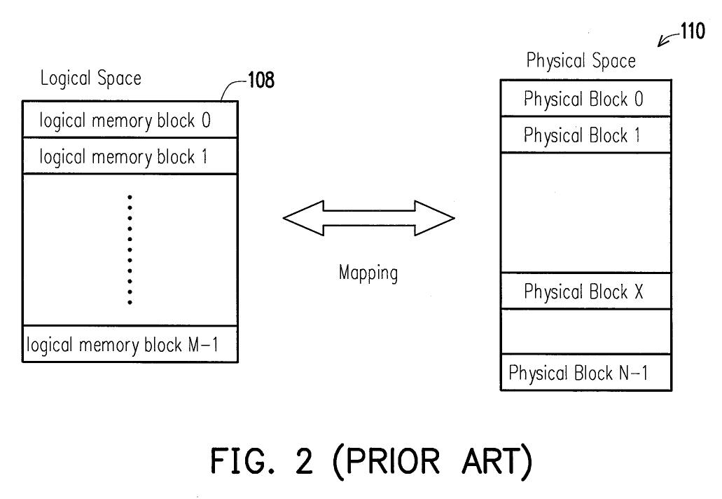

FIGS. 3A-3B are drawings, schematically illustrating the conventional mapping architecture and how to recycle.

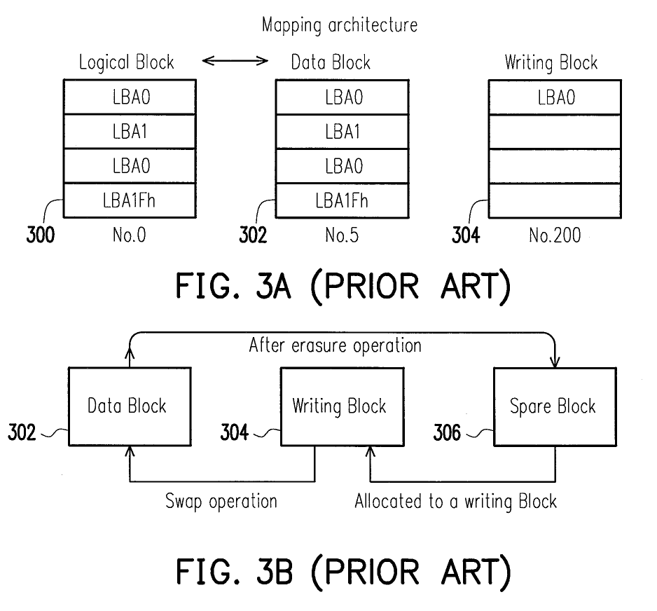

FIG. 4 is a drawing, schematically illustrating a process diagram for the conventional writing operation.

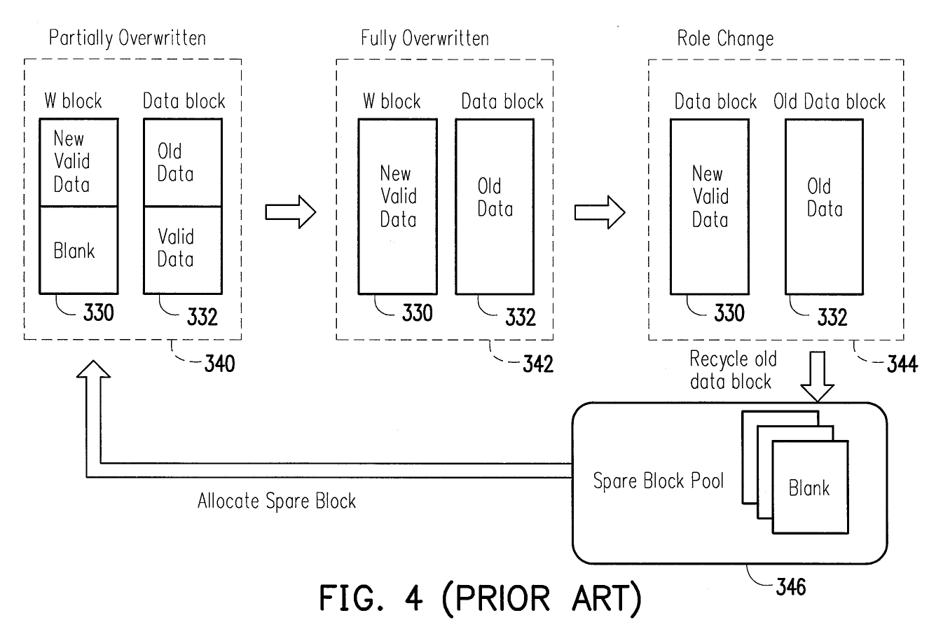

FIG. 5 is a drawing, schematically illustrating a recycle mechanism of an access operation by a host based on turbo units, according to an embodiment of the present invention.

FIG. 6 is a drawing, schematically illustrating a process diagram for the writing operation based on turbo units, according to an embodiment of the present invention.

FIG. 7 is a drawing, schematically illustrating a recycle mechanism of an access operation by a host based on data block and turbo units, according to another embodiment of the present invention.

FIG. 8 is a drawing, schematically illustrating a process diagram for the writing operation based on data block and turbo unit, according to an embodiment of the present invention.

FIG. 9 is a drawing, schematically illustrating a background clean-up mechanism of an access operation by a host based on data block and turbo units, according to another embodiment of the present invention.

### DESCRIPTION OF THE PREFERRED EMBODIMENTS

The invention provides a mechanism for a writing process by a host based on the multi-level cell (MLC) block structure. The invention can improve writing speed and reduce the data error probability caused by unexpected power down.

The conventional structure of memory cells is single-level cell (SLC), which can store one logical data bit. However, in the later development, one memory cell is no longer just storing one logical data bit. It can store multiple logical data bits, such as 2-bit or even more bits. This kind of memory is called multi-level cell (MLC) memory. The MLC nonvolatile memory is formed by a plurality of the MLC cells, which are also arranged into multiple MLC blocks. The per area storage capacity can be improved for the MLC nonvolatile memory. However, the programming time of the upper bit of the MLC memory cell is relatively long although the programming time of the lower bit is short. In total, the overall writing speed for the MLC cell becomes slower.

The present invention proposes a turbo unit, which is, for example, composed by two MLC blocks and only lower bit of each MLC cell of each of the MLC block of the turbo unit is used for storing data because the writing speed of the upper bit of each memory cell is slower than that of the lower bit. In this manner, the host will observe a faster writing speed. The turbo writing unit can also be formed by one MLC block at a time, but for the purpose of ease of explanation, only grouping of more than one MLC blocks to form turbo units are illustrated and introduced here.

Another improvement of the present invention is to prevent data error from unexpected power failure. Normally, when writing two logic data bits to the 4-level MLC cell, writing the lower bit is followed by writing the upper bit. While programming the upper bit, the lower bit will be affected hence the data stored in the lower bit may go wrong if the programming of the upper bit is not properly terminated. For example, if power loss suddenly happens during programming period of the upper bit, it may cause data error on the lower bit. In the present invention, if there's only one bit in MLC cell is programmed, the previously stored data in the MLC block can still remain correct even when sudden power loss happens. Moreover, in this invention, the MLC blocks which form the turbo unit are from a common spare block pool which comprises at least a portion of the MLC blocks of the MLC nonvolatile memory available to be allocated for writing data. No dedicated blocks are assigned to form the turbo units. This arrangement can guarantee a better global wear leveling characteristic. The current invention also proposes that through a clean-up process, the data in a turbo unit are copied to a MLC block in which each MLC memory cell stores all the logical data bits it is capable of storing. After the clean-up process, the MLC blocks that form the turbo data unit can be re-cycled and become available to be allocated for writing data In this manner, the main storage space will not need to be sacrificed. In the following description, “turbo” is defined as above. The data block means the normal MLC data block in which each MCL memory cell stores all the logical data bits is capable of storing

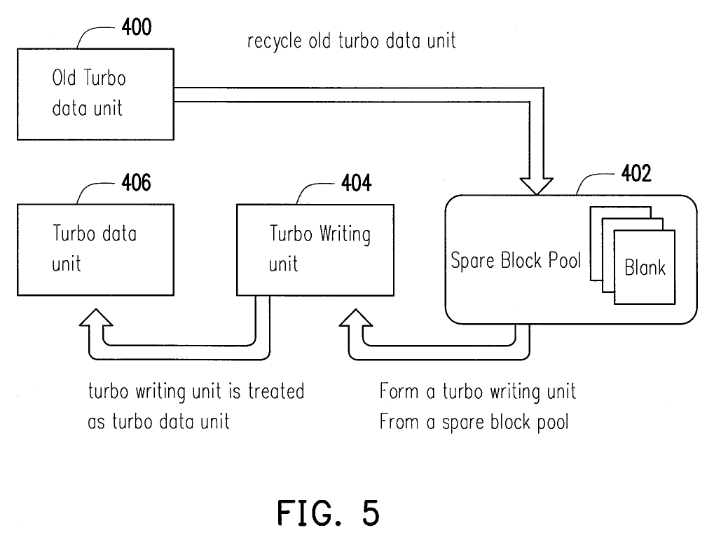

Several embodiments are provided for the description of the inventions. However, the invention is not just limited to the embodiments. Also and, the embodiments to each other can be properly combined for another embodiments. In other words, the embodiments as to be described in FIGS. 5-9 are just the examples without limiting the invention.

FIG. 5 is a drawing, schematically illustrating a recycle mechanism of an access operation by a host based on turbo units, according to an embodiment of the present invention.; In FIG. 5, a host is to write data to the logical location associated to an old turbo data unit 400. According to the recycling mechanism, the data are written to a turbo writing unit 404, which is allocated from a spare block pool 402. The spare block pool 402 comprises at least a portion of the MLC blocks of the MLC nonvolatile memory available to be allocated for writing data. In the example of 4-level MLC block, each turbo writing unit 404 has two MLC blocks and only one logical data bit is stored in each MLC memory cell of the MLC block. In this manner, the writing speed is faster and the previously stored data will not be error due to unexpected power down.

When writing of the turbo writing unit 404 is finished, the-turbo writing unit 404 is treated as a turbo data unit, say 406. The old turbo data unit 400 which stores the old data can now be recycled into the spare block pool 402 for later use.

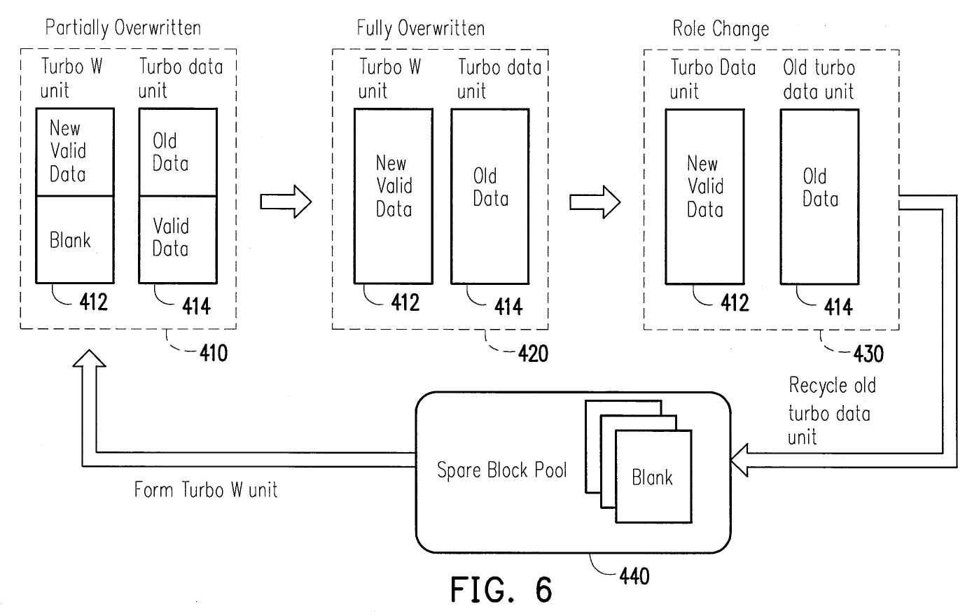

FIG. 6 is a drawing, schematically illustrating a process diagram for the writing operation based on turbo units, according to an embodiment of the present invention. In stage 410 of FIG. 6, the host is to write data to the logical location associated to the turbo data unit 414. The data are actually written to the turbo writing (W) unit 412 allocated from the spare block pool by the memory controller. In stage 410, the logical location associated to the turbo data unit 414 are partially overwritten indicated by new valid data in the turbo writing unit 412. The data stored in the correspondent portion in the turbo data unit 414 in stage 410 are no longer used and are indicated as old data. In stage 420, the turbo writing unit 412 has been written with the updated data and the turbo data unit 414 now just stores the old data. In stage 430, the turbo writing unit 412 now replaces the old turbo data unit 414 and is treated as the turbo data unit 412, which stores the newly updated valid data. The old turbo data unit 414 is then recycled into the spare block pool 440 for later use.

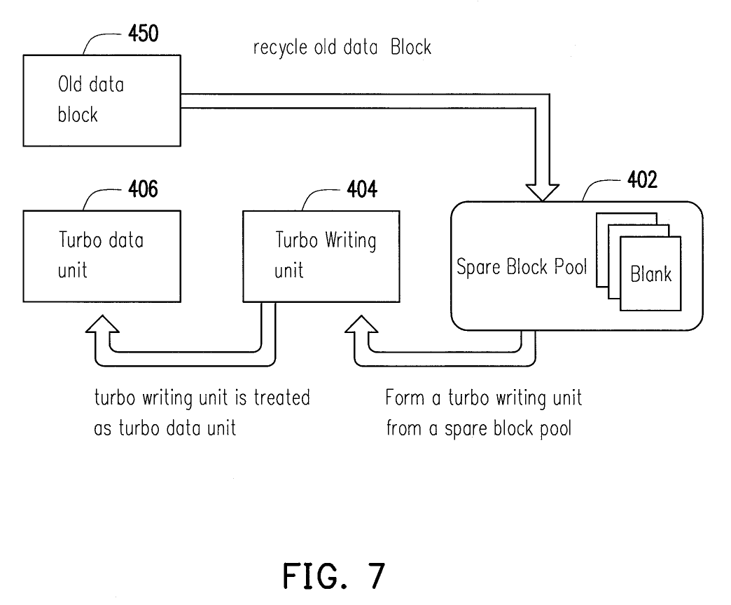

Normally, the turbo data unit 406 will be cleaned up which means the data in turbo unit will be copied to form the normal MLC data block through a clean-up process. When host writes data to the logical location associated to the normal MLC data block, the turbo writing unit in foregoing mechanism can be applied. FIG. 7 is a drawing, schematically illustrating a recycle mechanism of an access operation by a host based on data block and turbo units, according to another embodiment of the present invention. The host intends to write data to the logical location associated to the old data block 450, and the turbo writing unit 404 is allocated from the spare block pool 402 and data from the host is written to the turbo writing unit 404. After the writing of the turbo writing unit 404 is finished, the turbo writing unit is treated as the turbo data unit 406 and replaces the old data block unit 450. The old data block 450 is then recycled into the spare block pool 402.

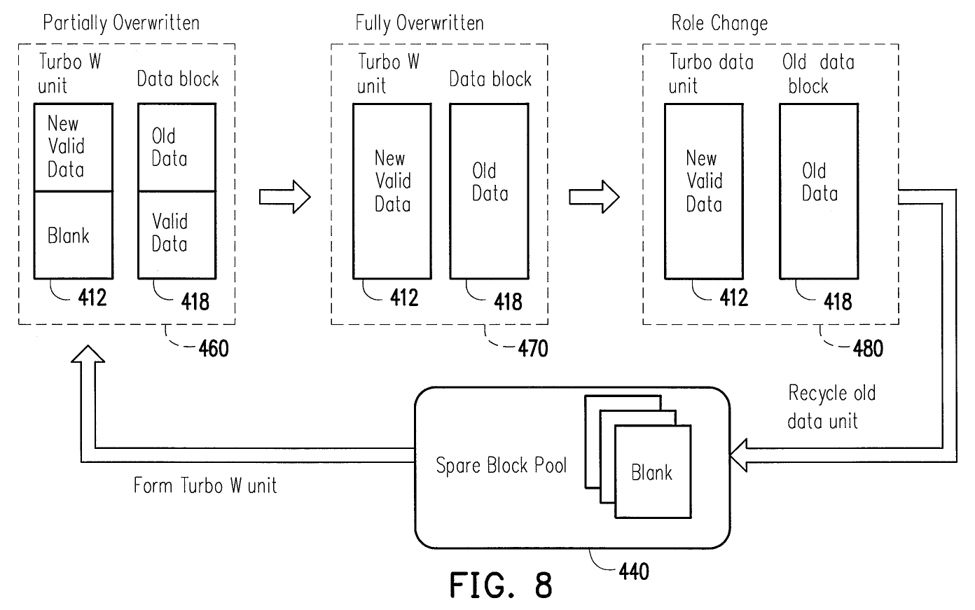

FIG. 8 is a drawing, schematically illustrating a process diagram for the writing operation based on data block and turbo units, according to an embodiment of the present invention. In stage 460 of FIG. 8, when the host intends to write data to the logical location associated to the data block 418, the data are actually written to the turbo writing block 412 allocated from the spare block pool 440 by the memory controller.

In stage 460, the logical location associated to the data block 418 are partially updated, indicated by new valid data in the turbo writing unit 412, and the correspondent portion of the data block 418 are indicated as the old data. In stage 470, the writing of the turbo writing unit 412 has finished, and the data block 418 now just stores the old invalid data. In stage 480, the turbo writing unit 412 now replaces the old data block and is treated as the turbo data unit 412, which stores the newly updated valid data. And then, the old data block 418 is recycled into the spare block pool 440 for later use.

In general case, the turbo data unit 406 will be cleaned up and the data in the turbo data unit will be copied to form the normal data block. A copy of valid data are still stored in the turbo data unit until after the valid data in turbo data unit are copied to form the normal MLC data block.

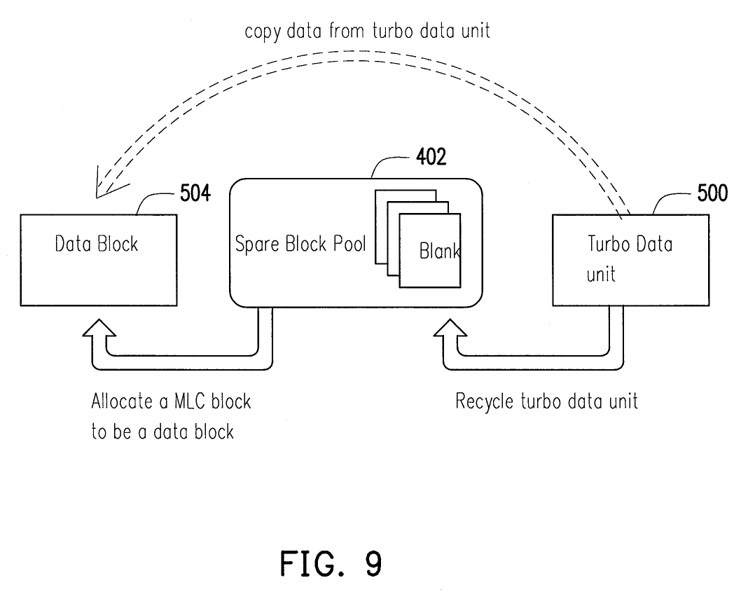

FIG. 9 is a drawing, schematically illustrating a clean-up process of an access operation by a host based on data block and turbo units, according to another embodiment of the present invention. The clean-up process can be performed in the background manner. In FIG. 9, a data block 504 is allocated from the spare block pool 402. The data in turbo data unit 500 are copied to the data block 504 in which each MLC cell stores all the logical data bits it is capable of storing. After then, the turbo data unit 500 is replaced by the data block 504 and two MLC blocks which form the turbo data unit 500 can be released. The released MLC blocks are then recycled into the spare block pool 402. The clean-up process can be executed at the time when the memory controller is free from serving the commands issued by the host. This manner is also called a background clean-up process and it does not affect the access efficiency of the host.

The clean-up process can reduce the total number of the turbo data units in use and release the MLC blocks into the spare block pool for later use. However, if host constantly writes mass data to the storage device, the controller could probably get no time to execute the clean-up process. The total number of the turbo units will increase fast and the available MLC blocks in the spare block pool will be used up quickly. It will then lower the writing performance on the host interface. It is possible to regulate the host writing performance at a desired speed by forming the turbo writing unit only under certain conditions. One example of the implementations is to form the turbo writing unit when the total number of the turbo data units and the turbo writing units in use doesn't exceed a preset threshold. Another example of the implementation is to form the turbo unit when the total number of the available MLC blocks in the spare block pool is larger than a preset threshold. Or, form the turbo unit when the number of turbo units doesn't exceed a first preset threshold and the number of the available MLC blocks in the spare block pool is larger than a second preset threshold. A conventional writing block with one MLC block can be allocated in stead of the turbo data block when the conditions described above are not qualified.

The present invention particularly proposes the turbo writing unit, so that the writing performance can be improved. The 4-level MLC cell is taken as an example, the turbo data unit is formed with two MLC blocks and only the lower bit of each of the MLC cell of the MLC blocks is used to store data. The MLC block can be written in faster speed without being limited by the speed of programming the upper bits of each MLC cells, hence the writing performance can be improved. In addition, when the power is suddenly down during programming the upper bit on the normal MLC data block, the data of the lower bit could be affected and might go wrong if the programming is not terminated properly. The turbo data unit not storing data with all of the logical data bits on which the MLC cell is capable of storing can solve this problem. For example, in the 4-level MLC memory, the present invention only uses lower bit to store data, so even if unexpected power failure happens, none of the previously stored data will be affected.

As previously stated, the same principle can be applied for the MLC block with 3 or more logical data bits in storage capacity. For example, for the 3-bit MLC cell, three MLC blocks can form a turbo unit for writing or storing data instead of single MLC block. The 3-bit MLC memory cells of the turbo writing unit can be used to store either one or two logical data bits.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A method for managing a writing operation from a host for a multi-level cell (MLC) nonvolatile memory having multiple MLC blocks, the method comprising:
arranging a spare block pool comprising at least a portion of the MLC blocks of the MLC nonvolatile memory available to be allocated for writing data;
forming a turbo writing unit from a spare block pool;
writing a data sent by the host to the turbo writing unit;
after finishing writing the turbo writing unit, the turbo writing unit is treated as a turbo data unit; and
copying the data stored in the turbo data unit into one of the MLC blocks allocated from the spare-block pool to replace the turbo data unit,
wherein the turbo writing unit is formed with at least one of the MLC blocks, not all of the MLC cells of the at least one of the MLC blocks store data with all of the logical data bits on which the MLC cell is capable of storing.

2. The method of claim 1, wherein the step of forming the turbo writing unit is to form the turbo writing unit with two of the MLC blocks, wherein each of the MLC cell of the MLC blocks has a storage capacity of two logical data bits.

3. The method of claim 2, wherein each of the MLC cell stores at least one logical data bit while it is capable of storing two logical data bits.

4. The method of claim 1, wherein the step of forming the turbo writing unit is forming the turbo writing unit with three of the MLC blocks, wherein each of the MLC cell of the MLC blocks has a storage capacity of three logical data bits.

5. The method of claim 4, wherein each MLC cell stores at least one logical data bit while the MLC cell of the MLC blocks is capable of storing three logical data bits.

6. The method of claim 1, wherein the step of forming the turbo writing unit is performed when the total number of the turbo writing units and the turbo data unit in use doesn't exceed a presetable threshold.

7. The method of claim 1, wherein the turbo writing unit is formed to write the data from the host when the total number of the available MLC blocks in the spare block pool is larger than a presetable threshold.

8. The method of claim 1, further comprising copying the data stored in the turbo data unit into one of the MLC blocks allocated from the spare block pool to serve as a data block for replacing the turbo data unit.

9. A block structure for a multi-level cell (MLC) nonvolatile memory, the MLC nonvolatile memory having a plurality of MLC blocks, each MLC cell of each MLC block can store multiple bits of data, the block structure comprising:
a spare block pool, comprising at least a portion of the MLC blocks of the MLC nonvolatile memory available to be allocated for writing data;
a turbo writing unit, allocated from the spare block pool for storing data from a host, wherein the turbo writing unit comprises at least one of the MLC blocks, not all of the MLC cells of the at least one of the MLC blocks store data with all of the logical data bits on which the MLC cell is capable of storing;.
a turbo data unit, wherein after finishing writing data to the turbo writing unit, the turbo writing unit is treated as the turbo data unit; and
a data block, as one of the MLC blocks allocated from the spare block pool for storing the data copied from the turbo data unit.

10. The block structure of claim 9, wherein the turbo writing unit comprises two blocks of the MLC blocks.

11. The block structure of claim 10, wherein each MLC cell has a storage capacity of two logical data bits.

12. The block structure of claim 9, wherein the turbo writing unit comprises three blocks of the MLC blocks.

13. The block structure of claim 12, wherein each MLC cell has a storage capacity of three logical data bits.

14. The block structure of claim 9, wherein the turbo writing unit is allocated to write the data from the host when the total number of the sum of the turbo data units and the turbo writing units in use doesn't exceed a preset threshold.

15. The block structure of claim 9, wherein the turbo writing unit-is allocated to write the data from the host when the total number of the available MLC blocks in the spare block pool is larger than a preset threshold.
